(19) United States
(12) Patent Application Publication
(10) Pub. No.: US 2026/0335986 A1
(43) Pub. Date: Oct. 29, 2026

(54) MACHINE TOOL UNIT WITH A TOOL SENSOR FOR SENSING THE LOADING OF A TOOL

(71) Applicant: Franz Kessler GmbH, Bad Buchau (DE)

(72) Inventors: Joachim VAN SPRANG, Ravensburg (DE); Sebastian WEBER, Bad Schussenried (DE); Harald WEING, Biberach (DE)

(73) Assignee: Franz Kessler GmbH, Bad Buchau (DE)

(21) Appl. No.: 19/102,635

(22) PCT Filed: Dec. 9, 2022
(86) PCT No.: PCT/EP2022/085148

§ 371 Date: Feb. 10, 2025

(30) Foreign Application Priority Data
Aug. 11, 2022 (DE) 10 2022 120 372.7

(51) Int. Cl. B23B 31/26; B23Q 17/00; G01L 5/00

(52) U.S. Cl. CPC B23B 31/265; B23Q 17/003; B23Q 17/005; G01L 5/0042; B23Q 2220/006

(57) ABSTRACT

A motor-driven machine tool unit includes a stator unit and a rotor unit which has at least one rotor shaft and which is rotatable about an axis of rotation. The rotor unit includes at least one tool fitting unit having a tool clamping device for fixing and clamping a releasably fixable tool shank of a tool. At least one tool sensor is configured to detect a load on the tool. At least a first spindle bearing and a second spindle bearing are provided between the rotor unit and the stator unit. As viewed in the axial direction, the at least one tool sensor is arranged between the first spindle bearing and the tool clamping device and/or the tool shank. At least one weakening structure is provided between the tool sensor and the axis of rotation in order to increase a mechanical deflection when the tool is under load and/or in the case of a changed load situation of the rotor unit or parts of the rotor unit.

### CROSS-REFERENCE TO RELATED APPLICATIONS

This Application is a Section 371 National Stage Application of International Application No. PCT/EP2022/085148, filed Dec. 9, 2022, and published as WO 2024/032920A1 on Feb. 15, 2024, and claims priority to German Application No. 102022120372.7, filed Aug. 11, 2022; the contents of each application are hereby incorporated by reference in their entirety.

### BRIEF DESCRIPTION OF THE DRAWINGS

FIG. 1 shows a schematic illustration of a first machine tool unit according to one example.

FIG. 2 shows schematic illustrations of three different spindle designs according to the prior art.

FIG. 3 shows a schematic sectional detail view of a motor spindle having a radial sensor according to the prior art.

FIG. 4 shows a schematic sectional detail view of a further motor spindle having an axial sensor according to the prior art.

FIG. 5 shows a schematic illustration of a first sensor unit having a first recess according to one example.

FIG. 6 shows a schematic illustration of a second sensor unit having a second recess according to one example.

FIG. 7 shows a schematic illustration of a third sensor unit having a third recess according to one example.

FIG. 8 shows a schematic illustration of a fourth sensor unit having a first cantilever according to one example.

### DETAILED DESCRIPTION

The present disclosure relates to a motor-driven machine tool unit, such as a multi-axis rotary head or a motor spindle.

In the context of machine tools, various exchangeable devices and tools exist which are connected to the machine tool via standardized interfaces. These are predominantly tools which are connected to the machine tool spindle or motor spindle via a releasable cone connection and in the case of which so-called collet chucks are opened and closed by way of an axial movement, such that the axial force required for securely fastening the tool can be transmitted to the tool and can also be eliminated again at a later point in time.

EP 1 889 685 B1 has already disclosed a machine tool in which a dial gage is used to inspect the surface contour of the circumferential surface of the spindle head with regard to whether a deformation is present. Such a deformation is then attributed to the fact that a foreign body, such as a chip, has been clamped inter alia in the region between the tool outer surface and the inner surface of the tool fitting.

In view of the ever more stringent requirements with regard to accuracy and reliability in machine tools, this is however no longer sufficient.

It is an object of the present disclosure to propose a motor-driven machine tool unit which has improved accuracy and/or by means of which the precision of the machining by the corresponding machine tool can be improved.

Proceeding from a machine tool unit of the type mentioned in the introduction, said object is achieved by means of features described herein. Advantageous embodiments and refinements of the present disclosure are possible by means of the measures specified herein.

Accordingly, a machine tool unit according to the present disclosure is distinguished by the fact that at least one weakening structure is provided between the tool sensor and the axis of rotation in order to increase, and/or dampen to a lesser extent, a mechanical deflection when the tool is under load and/or in the case of a changed load situation of the rotor unit or parts thereof.

By means of said weakening structure, it is achieved that the sensitivity of the sensor arrangement is improved, and thus better results and higher accuracy are achieved. This has a positive effect on the precision of the machine tool. Here, “sensor arrangement” refers to the sensor and, or having, the sensor element that is to be sensed or to be detected. Owing to the advantageous greater deformation of the sensor element or changes in the sensor surface that is to be sensed and/or in the distance, which is to be detected, of the sensor element to the “actual” sensor, the sensor arrangement is accordingly significantly improved despite the fact that the “actual” sensor is (normally) not changed/improved.

The weakening structure is advantageously formed as a cantilever of the tool sensor and/or of a sensor element of the tool sensor. A weakening of a sensor element of the tool sensor is thus advantageously achieved, whereby the deflection or deformation of the sensor element or of the cantilever under corresponding load or in the case of a changed load situation is dampened to a lesser extent, and accordingly increased. This advantageously increases the sensitivity of the sensor arrangement.

In one advantageous variant of the present disclosure, the weakening structure is formed as a recess of the rotor unit and/or of the rotor shaft and/or as a recess of the tool fitting unit. Said recess weakens the stability of the corresponding component, such that a greater deformation and higher accuracy of the sensor arrangement are achieved.

The recess is advantageously formed on a radially outwardly oriented surface of the rotor unit and/or rotor shaft and/or tool fitting unit, and/or the recess is advantageously formed on a radially inwardly oriented surface of the rotor unit and/or rotor shaft and/or tool fitting unit.

Advantageous production of the recess is thus possible, such that the manufacturing complexity and/or the cost outlay is reduced.

For example, the weakening structure and/or the recess is arranged between the tool sensor and the tool fitting unit as viewed in the radial direction, and/or the weakening structure and/or the recess is arranged between the tool sensor and the axis of rotation as viewed in the radial direction. In initial tests, it has been found that, in this region, the weakening has a very positive effect on the measurable deformation and higher accuracy of the sensor arrangement.

It is advantageously the case that the weakening structure and/or the recess is arranged between the tool sensor and the first rolling bearing as viewed in the axial direction and/or the weakening structure and/or the recess is arranged between the tool fitting unit and the first rolling bearing as viewed in the axial direction. Here, too, the weakening has a positive effect on the achievable accuracy.

In one particular refinement of the present disclosure, the recess is formed as a cavity within the rotor unit, and in particular is completely surrounded by material and/or components of the rotor unit. For example, the weakening structure and/or the recess comprises at least air. Advantageous implementation of the recess is thus possible, such that the manufacturing complexity and/or the cost outlay is reduced.

The weakening structure advantageously comprises at least one plastics material. Alternatively or in combination with this, said weakening structure comprises at least one metal. In particular, the weakening structure does not consist of any steel, but instead consists for example of copper, aluminum or corresponding alloys or the like. This, too, can advantageously increase the sensitivity, and can furthermore be produced inexpensively.

In general, the rotor unit that rotates relative to the stator unit belongs to a motor spindle drive. The actual cutting tool (milling cutter, drill bit etc.) is in turn commonly held or clamped in a tool holder, which is in turn arranged in a tool clamping device, which is to be regarded as part of the spindle head of the rotor unit. For this purpose, the tool clamping device has a mount for a tool holder. The tool clamping device is commonly subjected to a clamping force and adjusted in a longitudinal direction of the axis of rotation. Here, a part of the clamping device can for example be pulled into a tapering receptacle such that the tool holder or the tool can in turn be clamped inter alia with a radially acting force. By eliminating the clamping force, the clamped tool can commonly be released again, and can be removed from the machine tool and/or exchanged.

The actual sensor is normally accommodated in a so-called sensor head; the sensor measures the distance thereof to the rotor unit and/or a/the sensor element, wherein the sensor or the major part of the sensor is itself commonly suitably arranged in the stator unit. The sensor data are advantageously processed and evaluated by means of an electronics unit or an evaluation electronics system, which may be computer-controlled.

The at least one sensor head is commonly arranged on the stator unit at a fixed position in the region of the tool clamping device, and can measure/detect both at the end face on the rotating spindle head of the rotor unit and/or laterally, that is to say commonly the so-called sensor element.

Sensors or sensor heads may however also be arranged so as to be variable in terms of position. In general, for example, a chip clamped between tool and tool clamping device/spindle/rotor unit has the effect that the tool no longer runs exactly centrally/straight about the axis of rotation, or that the tool clamping device is slightly (also elastically) deformed, and unchanged concentricity or unchanged axial run-out of the tool or tool holder or a rotation without an angular change can no longer be ensured. In general, a concentricity defect generally gives rise to a particular impairment in the machining process. Such displacements and/or deformations generally occur both laterally and at the end face/axially, and in principle can also be detected there. At the end face, a distance parallel to the axis of rotation is measured, and laterally, a distance radially with respect to the axis of rotation is measured. All such displacements and/or deformations, up to and including offsets of the rotor unit, can be determined in this way. With the weakening structure, the accuracy or sensitivity can be improved.

A measurement can in principle be performed at a 90° angle with respect to the surface and/or with respect to the axis of rotation of the rotor unit, or else at an angle that differs from this.

Specifically in the case of machine tools, high demands are placed on machining accuracy. The tool and thus the cutting edge/cutting edges must commonly be inserted and moved in the tool holder or in the tool clamping device in an exactly defined manner during the machining operation, in order that the workpiece to be machined is machined within the specified tolerance limits. Even if the machine tool and in particular the tool clamping device are manufactured with the required precision, additional factors come into play during the use of the machine, which can commonly prevent defined concentricity/axial run-out from being maintained or prevent an absence of angular errors. For example, during the operation of the machine, the chips that form during the machining operation can become stuck to the tool or jammed and cause the tool not to rotate in the actual target position.

An exemplary embodiment of the present disclosure is illustrated in the drawing and will be discussed in more detail below with reference to the figures.

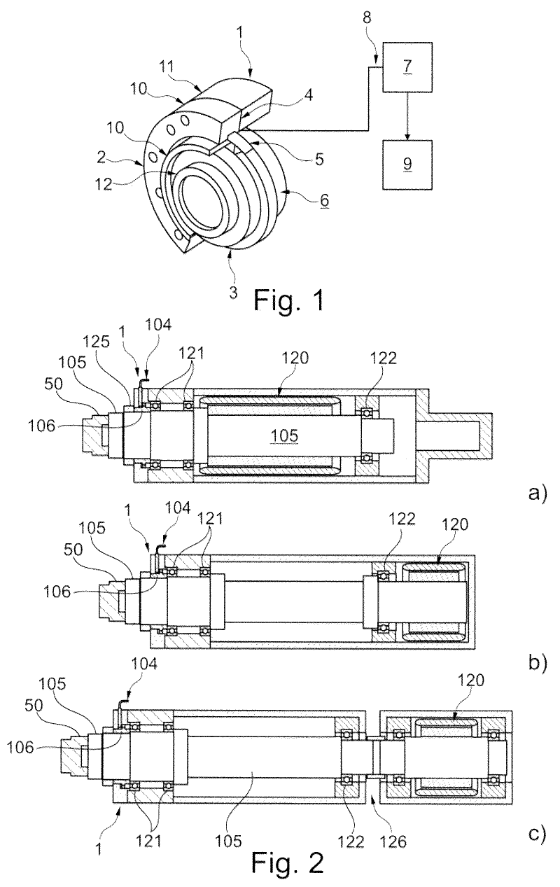

FIG. 1 shows a schematic illustration of a detail of a machine tool unit 1 with a part of a stator unit 2 and a part of a rotor unit 3, wherein FIG. 1 shows in particular a spindle head as part of the rotor unit 3. The stator unit 2 has, for example, a ring 4 to which, for example, a sensor head or sensor 5 in the form of an axial sensor is attached. The rotor unit 3 comprises, for example, a measuring ring or a sensor element 6 composed of a metal, which in this case is advantageously manufactured from a paramagnetic material. The axial sensor or sensor 5 is arranged so as to measure a distance to an end face of the rotor unit 3. A lateral measurement radially with respect to the axis of rotation D is however also conceivable. Said surface to which the distance is determined is situated on the measuring ring or sensor element 6. The axial sensor or sensor 5 is designed, for example, as an eddy-current sensor in order to be able to achieve the most exact possible measurements despite possible contamination.

The sensor head/axial sensor or sensor 5 is connected, for example, to an electronics unit 7; these together form an inspection device 8 which is in turn connected to a machine controller 9 such that control interventions can be performed as necessary in the event of excessive axial run-out.

In one particular refinement, for example, only one sensor head or sensor 5 is provided. It is conceivable to additionally use a trigger sensor, for example for detecting an optical reference marking on the measuring ring or sensor element 6; such a trigger sensor may for example also be attached to the sensor ring 4. The marking may also be in the form of a groove or the like. With such a trigger sensor, only the initial point for the measurements is triggered, in order that the phase relationships of the measured values with respect to one another can be more easily established during the evaluation. A trigger sensor is not imperatively necessary, and is also not illustrated in any more detail in FIG. 1.

The stator unit 2 comprises, for example, a cover 10 for the sensor ring 4, and also a bearing cover 11. A tool clamping device 12 is attached to the rotor unit 3 (the cone ring is illustrated in FIG. 1).

FIG. 2 schematically illustrates three different variants of spindles according to the prior art, wherein an electromagnetic drive system 120 is in the first case arranged between a so-called front spindle bearing arrangement 121 and a so-called rear spindle bearing arrangement 122 (cf. FIG. 2a)), or is arranged behind the so-called rear spindle bearing arrangement 122 (cf. FIG. 2b)), or is in turn arranged behind the so-called rear spindle bearing arrangement 122 (cf. FIG. 2c)) via a coupling unit 126. The spindle bearing arrangements 121, 122 are provided for supporting the rotatable rotor unit 3 or rotor shaft 105 or spindle shaft 105.

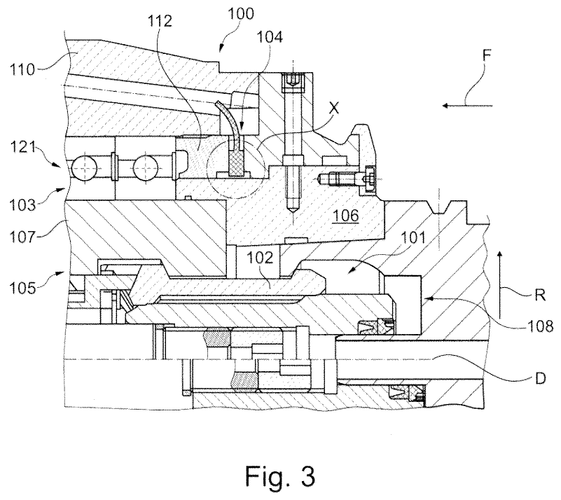

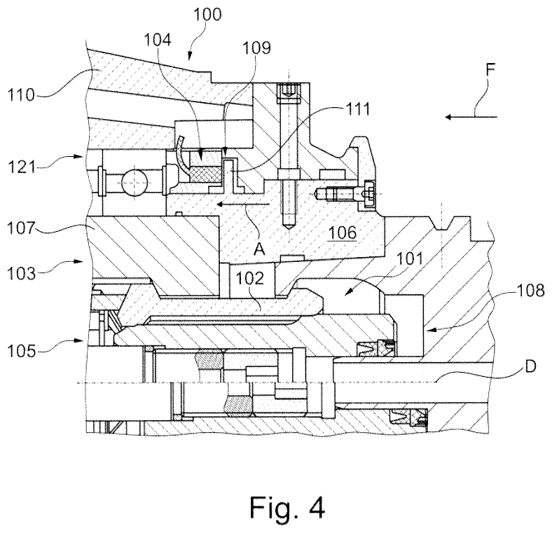

FIGS. 3 and 4 illustrate two further variants according to the prior art, with a motor spindle 3 of a machine tool being illustrated in section. As is conventional in machine tool engineering, one side of a collet chuck 1 having a plurality of clamping segments 2 is illustrated in the non-clamped state (the part that is almost not illustrated) and in the clamped state of the motor spindle 3 or of the collet chuck 101 or of the spindle head 1.

A sensor 104 can be seen in the illustrated, clamped part of the motor spindle 3 in FIGS. 3 and 4. In FIG. 3, said sensor 104 has a radially oriented operating region and, in FIG. 4, it has an operating region oriented along the axis of rotation D. Accordingly, FIG. 3 illustrates a radial sensor 104, and FIG. 4 illustrates an axial sensor 104. FIGS. 3 and 4 however do not show a second or third sensor that may optionally be used, because these, if used, would each be/are each arranged offset in the circumferential direction, in particular by 90° or 180°, and are therefore not visible in the sectional illustrations.

Changes in the spindle head 1 or owing to a load and/or force being applied to a tool (not illustrated in any more detail) or collet chuck 101 axially and/or radially in relation to the axis of rotation D, a region X, schematically illustrated in FIG. 3, of a spindle shaft 105 or of a counterholder 106 or stop/ring element 106 of the motor spindle 103 is deformed or expanded in the radial direction R. Here, an element 107 of the spindle shaft 105 transmits a clamping force F or displacement and/or deformation, that is to say change, to the element 106. A distance A or air gap 109 between the rotor unit or spindle shaft 105 and a stator unit 100 having the radial sensor 104 thus changes or decreases in size. The state according to the aforementioned reference measurement in the region X is the target state, and a change in the detected actual displacement and/or deformation owing to force/changes in the region of the spindle head 1, or the actual state, is correspondingly advantageously used for monitoring/controlling the motor spindle or rotor unit 3.

In FIG. 4, an axially oriented deformation of a measuring arm 111 can be detected by means of the axial sensor 104, or an axial change A in the distance 109 can be detected, and processed further. This axial change A arises in turn owing to a force/changes F at the tool 50 or at/in the spindle head 1 or axial and/or radial deformation/change at the tool 50 or spindle head 1, which is transmitted to the tool fitting unit 108 and to the element 106 and thus ultimately to the measuring arm 111 or the detectable sensor surface/distance 109 thereof.

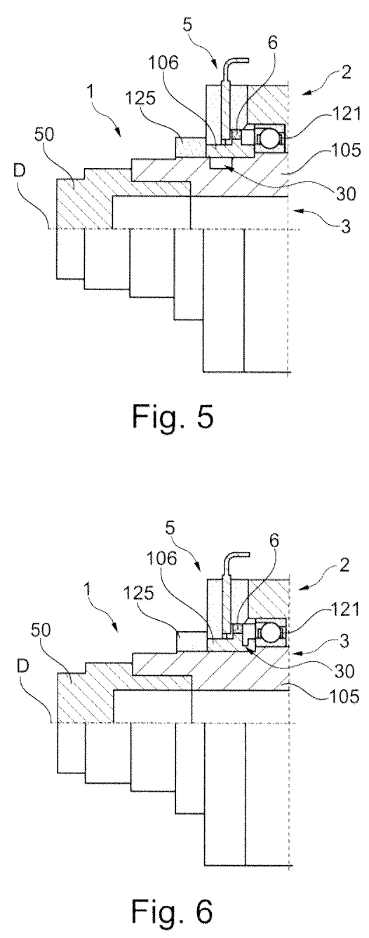

FIGS. 5 to 8 illustrate different variants according to the present disclosure (partially in section). Various weakening structures 30, 31 are provided here. A sensor element 6 or a sensor surface, which is spaced from and detectable by the sensor 5, of the sensor element 6 is arranged at/on the measuring ring 106 or is optionally formed as a single piece with the measuring ring 106 that is rotatable about the axis of rotation D. The measuring ring 106 is fixed, in particular pressed against the front bearing 121 or the inner ring thereof, by means of a threaded ring 125. In the variant in FIG. 5, a recess 30 is provided which is formed as a groove in the rotor shaft 105 or spindle shaft 105 and which is covered by the measuring ring 106.

In the variant in FIG. 6, a recess 30 is provided which is formed as a groove in the measuring ring 106 and which is implemented as an open groove.

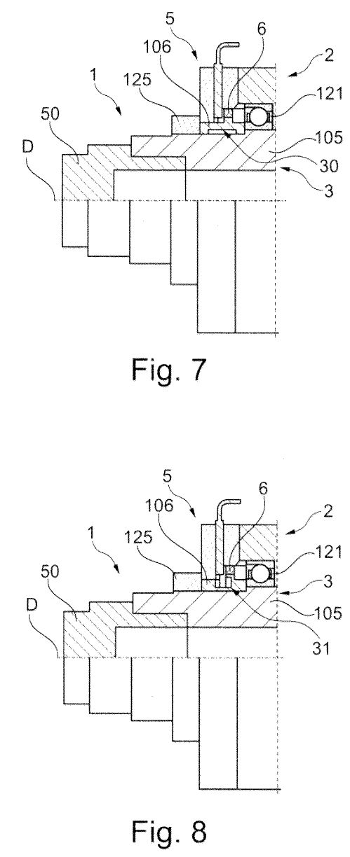

In the variant in FIG. 7, a recess 30 is provided which is formed as a groove in the measuring ring 106 and which is covered by the rotor shaft 105 or spindle shaft 105.

In the variant in FIG. 8, a recess of the measuring ring 106 is provided as a cantilever 31 on which the sensor element 6, or the sensor surface, which is spaced from and detectable by the sensor 5, of the sensor element 6 is arranged.

Although the present invention has been described with reference to embodiments, workers skilled in the art will recognize that changes may be made in form and detail without departing from the spirit and scope of the invention.

1. A motor-driven machine tool unit, comprising:
a stator unit, and
a rotor unit which has at least one rotor shaft and which is rotatable about an axis of rotation, wherein
the rotor unit comprises at least one tool fitting unit having a tool clamping device, for fixing and clamping a releasably fixable tool shank of a tool,
at least one tool sensor is configured to detect a load on the tool,
a distance is provided between the at least one tool sensor and the axis of rotation,
at least a first spindle bearing and a second spindle bearing are provided between the rotor unit and the stator unit, and
as viewed in the axial direction, the at least one tool sensor is arranged between the first spindle bearing and the tool clamping device and/or the tool shank, and
at least one weakening structure is provided between the tool sensor and the axis of rotation in order to increase a mechanical deflection when the tool is under load and/or in the case of a changed load situation of the rotor unit or parts of the rotor unit.

2. The motor-driven machine tool unit as claimed in claim 1, wherein the at least one weakening structure is formed as a cantilever of the tool sensor and/or of a sensor element of the tool sensor.

3. The motor-driven machine tool unit as claimed in claim 1, wherein the at least one weakening structure is formed as a recess of the rotor unit and/or of the at least one rotor shaft.

4. The motor-driven machine tool unit as claimed in claim 1, wherein the at least one weakening structure is formed as a recess of the at least one tool fitting unit.

5. The motor-driven machine tool unit as claimed in claim 4, wherein the recess is formed on a radially outwardly oriented surface of the rotor unit and/or the at least one rotor shaft and/or the at least one tool fitting unit.

6. The motor-driven machine tool unit as claimed in claim 4, wherein the recess is formed on a radially inwardly oriented surface of the rotor unit and/or the at least one rotor shaft and/or the at least one tool fitting unit.

7. The motor-driven machine tool unit as claimed in claim 4, wherein the at least one weakening structure and/or the recess is arranged between the at least one tool sensor and the at least one tool fitting unit as viewed in the radial direction.

8. The motor-driven machine tool unit as claimed in claim 4, wherein the at least one weakening structure and/or the recess is arranged between the tool sensor and the axis of rotation as viewed in the radial direction.

9. The motor-driven machine tool unit as claimed in

4, wherein the at least one weakening structure and/or the recess is arranged between the tool sensor and the first spindle bearing as viewed in the axial direction.

10. The motor-driven machine tool unit as claimed in claim 4, wherein the weakening structure and/or the recess is arranged between the at least one tool fitting unit and the first spindle bearing as viewed in the axial direction.

11. The motor-driven machine tool unit as claimed in claim 4, wherein the recess is formed as a cavity within the rotor unit, and in particular is completely surrounded by material and/or components of the rotor unit.

12. The motor-driven machine tool unit as claimed in claim 4, wherein the weakening structure and/or the recess comprises at least air.

13. The motor-driven machine tool unit as claimed in claim 1, wherein the weakening structure comprises at least one plastics material.

14. The motor-driven machine tool unit as claimed in claim 1, wherein the weakening structure comprises at least one metal and/or does not consist of any steel.

15. A machine tool comprising:
a stator unit, and
a rotor unit which has at least one rotor shaft rotatable about an axis of rotation, wherein the rotor unit comprises at least one tool fitting unit having a tool clamping device configured to releasably clamp a tool shank of a tool, wherein
at least one tool sensor is configured to detect a load on the tool,
at least a first spindle bearing and a second spindle bearing are located between the rotor unit and the stator unit, and
as viewed in the axial direction, the at least one tool sensor is arranged between the first spindle bearing and the tool clamping device and/or the tool shank, and
at least one weakening structure is provided between the tool sensor and the axis of rotation in order to increase a mechanical deflection when the tool is under load and/or in the case of a changed load situation of the rotor unit or parts of the rotor unit.

16. The motor-driven machine tool unit as claimed in claim 1, wherein the motor-driven machine tool unit comprises a multi-axis rotary head or a motor spindle.

17. The motor-driven machine tool unit as claimed in claim 1, wherein the tool clamping device is adjustable in a longitudinal direction of the axis of rotation.

18. The motor-driven machine tool unit as claimed in claim 1, wherein the first spindle bearing comprises a front rolling bearing.

19. The motor-driven machine tool unit as claimed in claim 18, wherein the second spindle bearing comprises a rear rolling bearing.

20. The motor-driven machine tool unit as claimed in claim 1, and further comprising at least one electromagnetic drive system arranged between the first spindle bearing and the second spindle bearing as viewed in the axial direction.
